(19) United States
(12) Patent Application Publication
(10) Pub. No.: US 2011/0149279 A1
(43) Pub. Date: Jun. 23, 2011

(54) APPARATUS AND METHOD FOR MEASURING THE MERCURY CONTENT OF A GAS

(75) Inventor: Rolf DISCH, Eichstetten (DE)

(73) Assignee: SICK MAIHAK GMBH, Waldkirch (DE)

(21) Appl. No.: 12/948,314

(22) Filed: Nov. 17, 2010

(30) Foreign Application Priority Data
Dec. 18, 2009 (EP) 09179843.9

(51) Int. Cl. G01J 3/42

(52) U.S. Cl. 356/300

(57) ABSTRACT

The invention relates to an apparatus for the measurement of the mercury content of a gas the apparatus comprising:
a light source for transmitting the spectral lines of mercury along an optical axis,
a magnetic field produced by a magnet which magnetic field is aligned perpendicular to the optical axis at a position where the light is generated for the production of σ+, σ− and Π polarized Zeeman components of the spectral lines in a light beam,
an optical separation device for separating the Zeeman components which includes a photo-elastic modulator,
a measurement cell for the gas to be measured,
a light receiver and
an evaluation unit for determining the mercury concentration in the gas by means of the amount of light incident on the light receiver.

To provide an improved apparatus for the measurement of the mercury content of a gas and a corresponding method with which, in particular more precise and more sensitive mercury concentration measurements are possible, it is suggested that the light source includes mercury having a natural isotope distribution and that the separation device includes a photo-elastic modulator.

The invention relates to an apparatus for measuring the mercury content of a gas in accordance with the preamble of claim 1 as well as to a corresponding method.

From U.S. Pat. No. 3,914,054 a type of apparatus for the measurement of the mercury concentration of a gas is known. This apparatus has an electrode-free mercury lamp as a light source from which the spectral lines of the isotopically pure ¹⁹⁹Hg are emitted along an optical axis. The light source is arranged in a magnetic field so that the σ+, σ− and Π polarized Zeeman components of the spectral lines can be generated (transverse Zeeman effect). The light generated in this manner is guided through an absorption cell and into an optical separation device arranged downstream thereof in which the Zeeman components are separated. The optical separation device includes a beam separator so that a partial beam can be directly guided to a photo detector and the other partial beam runs through a mercury absorption cell in which the non-displaced spectral line, i.e. the Π component is absorbed so that only the displaced σ+ and σ− components can arrive at the second photo detector. Through a corresponding difference formation and evaluation of the intensities measured at both photo detectors one can deduce the absorption in the mercury measurement cell and thus deduce the mercury concentration of the gas to be measured.

An essential disadvantage of this known apparatus consists therein that the light source works with an isotopically pure mercury which is not only demanding in cost, but also strongly minimizes the availability of such a light source, as there are only a few producers of isotopically pure mercury lamps worldwide. A further essential disadvantage consists therein that the reference light, i.e. the σ+ and σ− Zeeman components which are not absorbed in the measurement cell and serve as a reference are guided in the optical separation device onto a first separate optical path (reference path) and the measurement light is guided onto a second optical path (measurement path). Due to the separation into a measurement path and a reference path intensity is lost using the beam separator so that, in particular the signal-to-noise-ratio is unfavorable. Further it is a disadvantage that the reference light has to pass through an additional absorption cell for the removal of the Π component which further reduces the intensity of the reference light. Furthermore, in reality it is not always ensured that a complete absorption occurs so that faulty results can occur. A further disadvantage of the separation of the measurement path and of the reference path is that these can possibly be subjected to different conditions, such as different temperatures, so that a different temperature behavior can lead to further faults. This holds, in particular for mercury measurements when one considers that the measurement cell is heated to very high temperatures (up to 1000° C.).

Starting from this prior art it is the object of the invention to provide an improved apparatus for measuring the mercury content of a gas and a corresponding method with which, in particular, the previously mentioned disadvantages can be avoided and more precise and more sensitive mercury concentration measurements are possible.

This object is satisfied by an apparatus having the features of claim 1 and a method having the features of claim 7.

The apparatus in accordance with the invention for the measurement of the mercury content in a gas includes:
a light source for transmitting a light beam having the spectral lines of mercury along an optical axis, wherein the light source contains mercury having a natural isotope distribution and the light source is adapted as an electrode-free gas discharge tube whose electrodes are designed as flat discs having a central opening and in whose openings the discharge tube is held,
a magnetic field produced by a magnet which magnetic field is aligned perpendicular to the optical axis at a position where the light is generated for the production of σ+, σ− and Π polarized Zeeman components of the spectral lines in the light beam,
an optical separation device for separating the Zeeman components which includes a photo-elastic modulator,
a measurement cell for the gas to be measured,
a light receiver and
an evaluation unit for determining the mercury concentration of the gas by means of an amount of light incident on the light receiver.

In accordance with the invention the light source includes mercury having a natural isotope distribution and the separation device includes a photo-elastic modulator.

Since the light source includes mercury in the natural isotope distribution and no isotopically pure mercury, such a light source can be produced considerably cheaper. Impurities, which would be disturbing for an isotopically pure light source, are insignificant. The availability of such a light source is considerably improved, since no limitation to only a few manufacturers is present.

A further considerable improvement relates to the separation device which now includes a photo-elastic modulator as an essential element so that a separation into a measurement path and a reference path by means of a beam divider is not necessary and thus, intensity can be won which leads to an improvement of the signal-to-noise-ratio. Furthermore, the reference light represents a reliable reference when it arrives at the same light receiver using the same optical path rather than a separation into a measurement path and a reference path being present and different detectors for the measurement light and the reference light being used as, is the case in the prior art. The measurement results are therefore more reliable, exacter and the apparatus have a higher detection efficiency.

Despite the use of natural mercury the advantage is maintained which utilizes the transverse Zeeman effect namely that both the measurement light (Π component) and also the reference light (σ+ and σ− components) are generated in the same light source, wherein the measurement light and the reference light advantageously lie spectrally very close to one another. The reference is maintained both on the high energy side and also on the low energy side of the measurement light through this so that cross-sensitivities can be significantly reduced. Thus, even interferences which are wavelength-dependent have no serious influence.

The light source is adapted as an electrode-free gas discharge tube whose electrodes are adapted as flat discs having a central opening in whose openings the discharge tube is held. It has been shown that such a design of the electrodes, i.e. when the actual contact surface between the discharge tube and the electrodes is as small as possible, leads to a significantly reduced blacking on the inside of the gas discharge tube, i.e. the lifetime of the discharge tube is significantly increased.

Advantageously the optical separation device and the measurement cell are arranged such that the light of the light source first passes through the optical separation device and then through the measurement cell.

In an embodiment of the invention the photo-elastic modulator is combined with a polarizer and a modulated potential having a predetermined frequency is applied thereto whereby a timely separation of the Zeeman component is maintained and indeed with a frequency which corresponds to the control of the photo-elastic modulator. In this embodiment a lock-in amplifier is simultaneously triggered with this frequency and the signal of the light receiver is guided to the lock-in amplifier. The measurement light and the reference light then pass through the measurement cell almost simultaneously and at the same position so that the reference light represents an ideal reference due to which also more exacter measurement results are obtained.

So that the reference light is significantly spectrally separated from the measurement light the magnetic field at the position of the light source is so strong that the Zeeman components of the natural mercury are spectrally separated. In particular, the magnetic field at the position of the light source is approximately 1 to 1.5 Tesla. In this respect one must ensure that the magnetic field is not only sufficiently strong, but is also as homogeneous as possible so that besides the spectral separation also a sufficient timely separation of the Zeeman components is ensured.

Advantageously the photo-elastic modulator is adapted as a λ/2 oscillator. Such a photo-elastic modulator is principally known from DE 4314535 C2 and has the particular advantage that it has a small construction size, is cheap and can be excited in a simple manner using a piezo crystal to excite oscillations, wherein the excitation can be controlled by a simple pick-up piezo.

The method in accordance with the invention for the operation of such an apparatus includes the following steps:
generation of an aligned light beam along an optical axis using a light source illuminating a gas discharge tube, wherein the light beam includes the spectral lines of mercury having a natural gas distribution and present in the gas discharge tube,
generation of a homogeneous magnetic field at the position of the gas discharge tube,
generation of the σ+, σ− and Π polarized Zeeman components of the spectral lines using the magnetic field,
separation of the Zeeman component by means of a combination of a photo-elastic modulator and polarizer,
guiding the light beam through the gas to be measured,
detecting the light beam following the passage through the gas,
evaluation of the intensity of the light beam in dependence on time and
determining the mercury content.

The advantages of the method in accordance with the invention have already been described above.

In the following the invention will be described in detail in accordance with an embodiment with reference to the drawing. In the drawing there is shown:

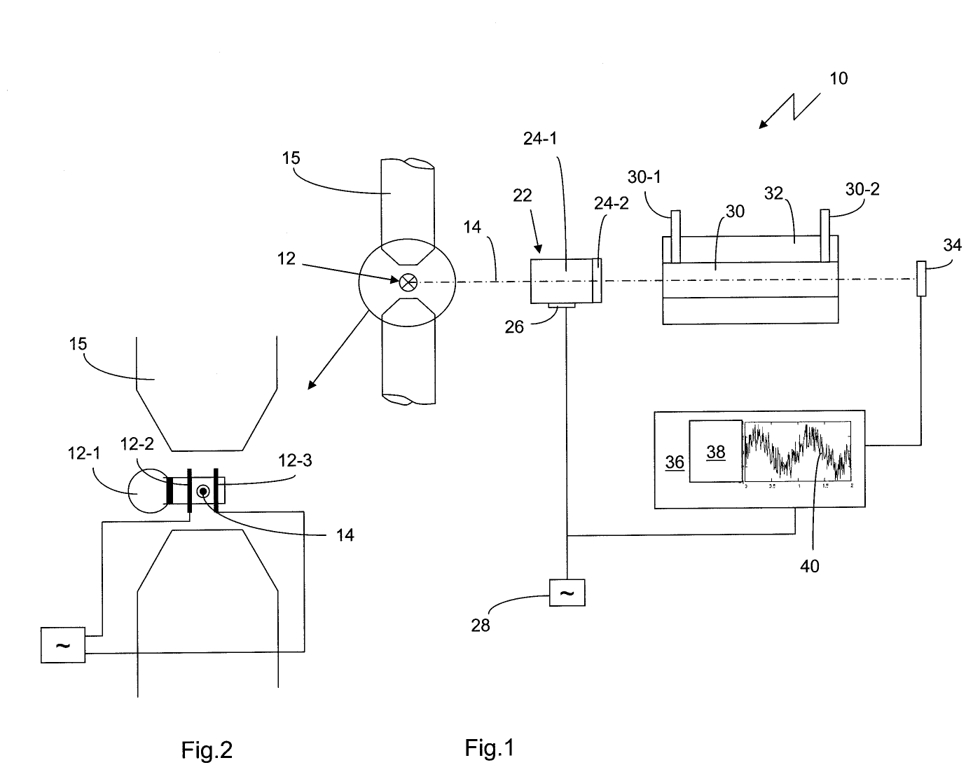

FIG. 1 a schematic illustration of an apparatus in accordance with the invention;

FIG. 2 the light source of the apparatus in accordance with the invention in schematic but slightly more detailed view;

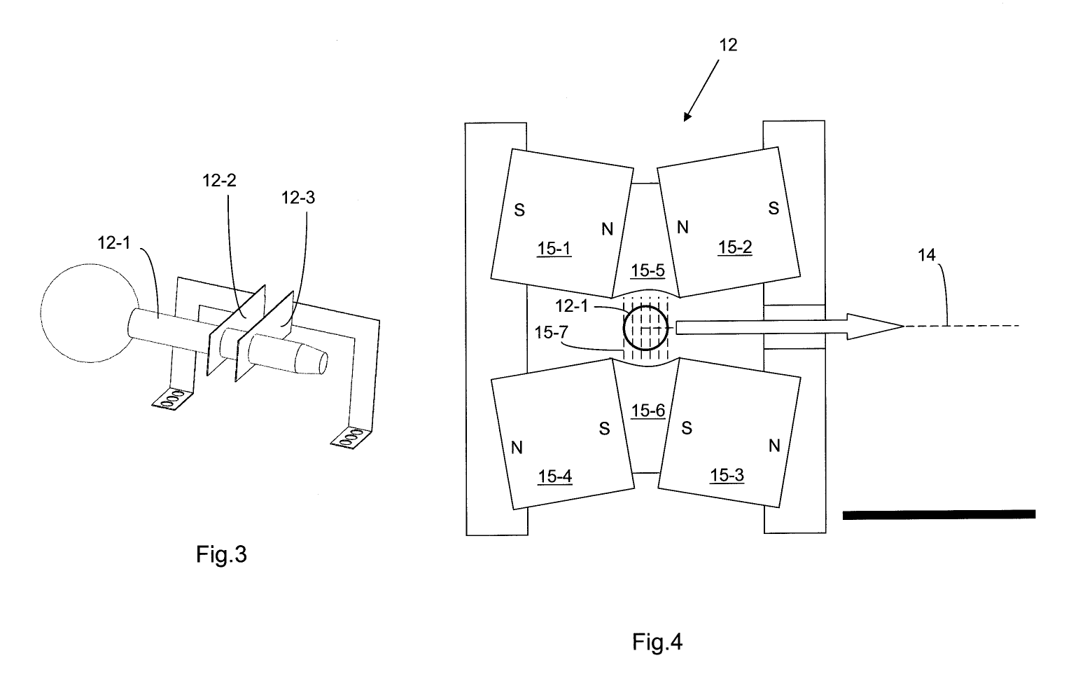

FIG. 3 parts of the light source;

FIG. 4 a further detailed illustration of the light source;

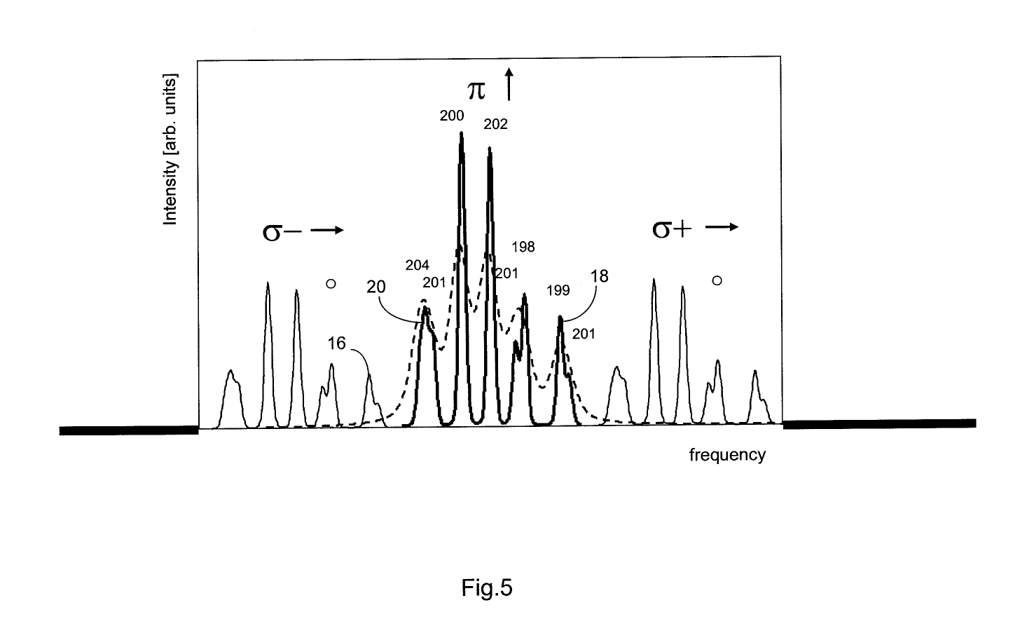

FIG. 5 a mercury spectrum of the light source;

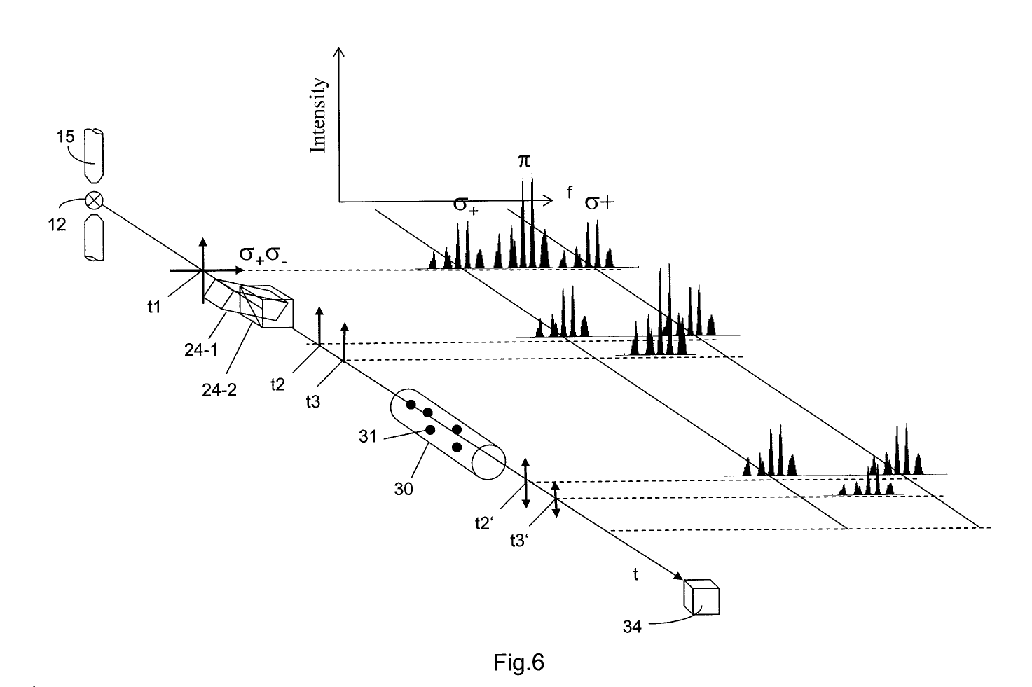

FIG. 6 an illustration of individual steps of the method in accordance with the invention.

As is schematically represented in FIG. 1, an apparatus 10 for measuring the mercury content of a gas includes a light source 12 for transmitting mercury spectral lines along an optical axis 14. The light source 12 shown in FIG. 2 in a detailed but still schematic illustration is designed as an electrode-free gas discharge lamp and includes a discharge tube 12-1 in which a gas discharge burns. Furthermore, the gas discharge tube 12-1 includes a mercury supply so that the mercury spectral lines can originate in the gas discharge. The mercury is a type of mercury having a natural isotope distribution. The gas discharge is ignited and maintained by two electrodes 12-2 and 12-3 which are arranged outside of the discharge tube 12-1 and are preferably constructed as flat discs having a central opening, with the discharge tube 12-1 being held in the openings, as is illustrated in FIG. 3. The light source is illustrated in FIG. 2, such that the optical axis 14 lies perpendicular to the plane of the drawing.

The light source 12 is positioned in a magnetic field which is as homogeneous as possible and is generated by a magnet 15 and is aligned at the position of the light generation perpendicular to the optical axis. The σ+, σ− and the Π polarized Zeeman components of these spectral lines are thereby produced due to the Zeeman Effect.

So that the splitting of the spectral lines is large enough and the spectral lines stay focused i.e. they are spectrally displaced at each position in the lamp by the same amount, a sufficiently large and homogeneous magnetic field has to be produced. For this reason the magnet 15 is adapted in a particular manner as is shown in FIG. 4. The magnet 15 which produces the homogeneous magnetic field is formed from a total of four individual magnets 15-1 to 15-4 so that a north pole is arranged on a side of the gas discharge tube 12-1 (above the gas discharge tube in FIG. 4) and a south pole is arranged on the opposite side (below the gas discharge tube in FIG. 4). The north pole of the magnet 15 is then formed through the two partial magnets 15-1 and 15-2, whose north poles lie opposite one another. In a corresponding manner the south pole of the magnet 15 is formed through the two south poles of the partial magnets 15-3 and 15-4. A gap is formed between the two opposing north poles of the partial magnets 15-1 and 15-2 as well as between the opposing south poles of the partial magnets 15-3 and 15-4 which widens towards the gas discharge tube 12-1. Both gaps are preferably each filled with an iron core 15-5 and 15-6, with the form of the ends of the iron cores facing the gas discharge tube 12-1 being concavely formed in the cross-section shown. The magnet 15 with its partial magnets and the iron cores can generate a particularly homogeneous magnetic field at the position of the gas discharge due to this design which is shown by the dotted lines 15-7.

FIG. 5 shows a spectrum generated by a mercury gas discharge lamp 12. The spectral lines, which are printed fatter, correspond to the Π component, with the individual spectral lines of the Π components corresponding to the different transitions of the different isotopes. The individual lines are marked by the respective mass number of the isotopes. The spectral lines of the σ+ component are located towards the higher frequencies and spectral lines of the σ− components are located towards the lower frequencies. The magnetic field at the position of the gas discharge is so strong that the spectral distribution of the σ+ and σ− components do not interfere with the distribution of the Π component. Typically the magnetic field is approximately 1 to 1.5 Tesla for this. This means that, e.g. the spectral line of the ¹⁹⁹Hg of the σ− component which is referred to using the reference numeral 16 and which corresponds to the spectral line having the highest energy of the Π component which is referred to using the reference numeral 18, is displaced to lower frequencies by so much that it is significantly separated from the spectral line of the Π component which is referred to using the reference numeral 20 and corresponds to the spectral line having the lowest energy of the Π component, i.e. the spectral line of ²⁰⁴Hg. The dotted line in FIG. 5 shows the natural distribution of Hg for normal pressure and at approximately 1000° C., as can be found in the measurement cell described below.

As is explained further below the sufficient separation is important, because the Π component finally delivers the measurement quantity as the undisplaced Π component is absorbed and the displaced cr components form a reference quantity, since the displaced spectral components are not absorbed as is principally already known from the state of the art (U.S. Pat. No. 3,914,054).

Further, the apparatus 10 has an optical separation device 22 with which the Zeeman components are separated as is discussed in detail further on. The optical separation device 22 has a photo-elastic modulator 24-1 as an essential element which is excited to resonant oscillations by a piezo 26, for which an alternating potential having a predetermined frequency is applied to the piezo 26 which is generated by a potential power supply device 28. Preferably the photo-elastic modulator is adapted as a λ/2 oscillator which is known in principle from the state of the art (DE 4314535 C2). A polarizer 24-2 is arranged downstream of the photo-elastic modulafor 24-1.

Furthermore, the apparatus 10 has a measurement cell 30 in which the gas to be measured having the mercury contaminants whose concentration should be measured is contained. The gas can, e.g. be guided into the measurement cell 30 via an inlet 30-1 and an outlet 30-2. As a rule, the measurement cell 30 has an inlet window and an outlet window so that light can illuminate the measurement cell 30. The measurement cell 30 has a heating 32 which heats the measurement gas to very high temperatures, e.g. approximately 1000° C., to provide the mercury in an unbound elementary state, i.e. an atomic state, in the gas phase for the absorption measurement.

Further, the apparatus 10 includes a light receiver 34 which receives the light of the light source which has passed the modulator 24 and the measurement cell 30 and measures its intensity. The signal of the light receiver 34 is guided to an evaluation unit 36 so that finally the mercury concentration of the gas can be determined in the measurement cell 30. For this reason the evaluation unit 36 includes a lock-in amplifier 38 which is triggered by the power supply 28.

In the following the functionality of the apparatus 10, i.e. a method for the operation of the apparatus 10 for the determination of the mercury content of the gas is explained in detail. For this reason particular reference is made to FIG. 6 in which the individual method steps are illustrated with reference to a time axis t.

The light generated in the light source 12 comprises the Zeeman components of the mercury spectral lines in accordance with FIG. 5, as was previously explained. Thus, at the point in time t the complete spectrum is present which comprise the linear polarized Π component and the σ+ and σ− components which are polarized perpendicular thereto.

When the light passes through the photo-elastic modular 24-1 the linearly polarized Π components are influenced differently than the polarized σ+ and σ− components perpendicular thereto due to the birefringent properties of the modulator 24-1. These different influences occur in synchronism to the applied alternating potential which is provided by the power supply 28. In combination with the photo-elastic modulator 24-1 having the polarizer 24-2, on the one hand, the polarization of the σ components is rotated and at predetermined times t2 only the σ+ and σ− components are let through and at predetermined times t3 only the Π component is let through. Thus, a timely separation of the Π component, on the one hand, and the σ+ and σ− components, on the other hand, is achieved in the optical separation device 22 comprising the photo-elastic modulator 24-1 and the polarizer 24-2.

Following this the light passes through the measurement cell 30 with the mercury atoms contained therein which are indicated in FIG. 6 using the reference numeral 31. The non-displaced spectral lines of the Π components experience an absorption at the mercury atoms in the measurement cell 30 in contrast to which the displaced σ+ and σ− components do not experience an absorption due to the energy displacement so that the light at these lines can serve as a reference light.

Finally the light is received at the light receiver 34 and guided to the lock-in amplifier 38 which is triggered by the alternating potential guided to the photo-elastic modulator 24. As a result a signal is obtained by means of the lock-in amplifier, as is shown qualitatively in FIG. 1 using the reference numeral 40. The light receiver 34 therefore alternatively receives reference light and the non-absorbed part of the measurement light having the frequency of the modulator control potential so that the difference thereof, i.e. the amplitude of curve 40, is a measure of the absorption in the measurement cell 30 and thus, a measure for the mercury concentration so that from the signal the concentration of the mercury in the gas to be analyzed can be determined.

1. An apparatus for measuring the mercury content of a gas,
having a light source for transmitting a light beam having the spectral lines of mercury along an optical axis, wherein the light source contains mercury having a natural isotope distribution and the light source is adapted as an electrode-free gas discharge tube whose electrodes are designed as flat discs having a central opening and in whose openings the discharge tube is held,
having a magnetic field produced by a magnet which magnetic field is aligned perpendicular to the optical axis at a position where the light is generated for the production of σ+, σ− and Π polarized Zeeman components of the spectral lines in the light beam,
having an optical separation device for separating the Zeeman components which includes a photo-elastic modulator,
having a measurement cell for the gas to be measured,
having a light receiver and
having an evaluation unit for determining the mercury concentration in the gas by means of an amount of light incident on the light receiver.

2. An apparatus in accordance with claim 1 wherein the optical separation device and the measurement cell are arranged such that the light of the light source first passes through the optical separation device and then through the measurement cell.

3. An apparatus in accordance claim 1 wherein a modulated potential of a predetermined frequency is applied to the photo-elastic modulator and together with a polarizer a timely separation of the Zeeman components is thereby maintained and the signal of the light receiver is guided to a Lock-In amplifier.

4. An apparatus in accordance with claim 1 wherein the magnetic field at the position of the light source is so strong that the Zeeman components of the natural mercury are spectrally separated and, in particular is 1 to 1.5 Tesla.

5. An apparatus in accordance with claim 1 wherein the photo-elastic modulator is adapted as a λ/2 oscillator.

6. A method for the operation of an apparatus for measuring the mercury content of a gas, the method having the following steps:
generation of a light beam along an optical axis using a light source illuminating a gas discharge tube, wherein the light source contains the spectral lines of mercury having a natural isotope distribution and present in the gas discharge tube,
generation of a homogenous magnetic field at the position of the gas discharge tube,
generation of the σ+, σ and Π polarized Zeeman components of the spectral lines using the magnetic field,
separating the Zeeman components by means of a combination of photo-elastic modulator and polarizer,
guiding the light beam through the gas to be measured,
detecting the light beam following the passage through the gas,
evaluation of the intensity of the light beam in dependence on time and
determining the mercury content.

7. A method in accordance with claim 6 wherein a modulated potential having a predetermined frequency is applied to the photo-elastic modulator and thereby a timely separation of the Zeeman components is achieved and that the signal of the light receiver is evaluated in a Lock-In method.

8. A method in accordance with claim 6 including the step of using a gas discharge tube having external electrodes.

9. A method in accordance with claim 8 wherein said electrodes are designed as flat discs having a central opening.
